(19) United States
(12) Patent Application Publication
(10) Pub. No.: US 2010/0039022 A1
(43) Pub. Date: Feb. 18, 2010

(54) TRICHROMATIC FIELD-EMISSION DISPLAY AND PHOSPHORS THEREOF

(76) Inventors: Soshchin NAUM, Changhua City (TW); Wei-Hung Lo, Taipei City (TW); Chi-Ruei Tsai, Taipei City (TW)

Correspondence Address: Guice Patents PLLC, 12647 Galveston Court #302, Manassas, VA, 20112, US

(21) Appl. No.: 12/540,519

(22) Filed: Aug. 13, 2009

(30) Foreign Application Priority Data
Aug. 15, 2008 (TW) 097131107

(51) Int. Cl. H01J 1/62

(52) U.S. Cl. 313/495

(57) ABSTRACT

A trichromatic field-emission display is disclosed to include a cathode plate, three cathode electroluminescent phosphor screens and an anode plate, the anode plate having a transparent oxide thin film bonded to the photo gate electrode thereof, electron sources emitted by the photo gate electrode of the cathode plate striking the cathode electroluminescent phosphor screens to cause change of the electric field in the gap between the cathode plate and the anode plate. The cathode electroluminescent phosphor screens are made of an excitable rare earth element, assuring high stability and uniformity of luminous brightness when excited by an electron beam.

### BACKGROUND OF THE INVENTION

1. Field of the Invention

The present invention relates to a device message display technology, and more particularly to a novel combination display combining a vacuum fluorescent display technique that uses carbon nano-tubes (CNTs) as field emitters to generate sufficient energy electron beams for striking a light emitting surface in a glass casing. This combination is called CNT-FED display. FED anode plate is realized in the form of RGB inorganic cathode electroluminescence phosphor.

2. Description of the Related Art

Starting from the early 40's of the 20^{th} century, cathode ray tube (CRT) has been used as independent electronic message display means. FIG. 1 illustrates a conventional CRT field-emission display screen architecture. In the photoelectric system inside the glass tube (picture tube), three hot cathodes are arranged. An electron beam moves back and forth through a meshed material 5 to strike the phosphor onto the inner surface 6 of the glass tube 1, thereby lighting up phosphor dots and illuminating the active portions of the screen. The light-emitting component (not shown) comprises three light-emitting colors, i.e., red (R), green (G) and blue (B).

When the energy in the electric field is accelerated to E=25 k electron volt, then the component starts emitting light (the so-called cathode electroluminescence). The number of pixels of this component is greater than 1×10⁶. The pixel size is about 250˜280 μm. Following the transverse tangent line, the electron beam surrounds the periphery inside the glass tube, establishing electroluminescence image brightness. The time of which the electron beam stays on the screen component is very short, not longer than 0.1 micro second. To obtain the requisite image brightness, the electron beam energy is very high, normally is about 25 k electron volt, and the frequency for image display is F=50 Hz.

Picture tube production capacity is large (annual capacity of the whole world is about 100 millions, or 40 millions in China). However, this structure of picture tube still has drawbacks: 1. High voltage applying, and professional X-ray radiation protection is necessary; 2. High fire risk due to high voltage applying in a picture tube; 3. Brightness difference upon striking of electron beam against different phosphor spots can cause tired eyes. To avoid this problem, it needs to keep away form the picture tube display at a distance of several meters; 4. The picture tube has a big volume with the dimension of over 50 cm in height, width and depth each; and 5. The heavy picture tube (10˜12 kg) uses a big amount of electrode material and glass.

To eliminate the aforesaid drawbacks, liquid crystal display (LCD) and plasma display panel (PDP) are created. LCD and PDP have the advantage of applying the smallest device thickness (device depth). However, LCD and PDP are inferior to CRT in many other parameters, such as 1. They have a high manufacturing cost, and every image component requires a specific memory; 2. They are temperature sensitive. LCD will stop functioning and PDP will lower its luminance when the operating temperature is inappropriate; 3. It is inconvenient to view the images on LCD or PDP screens at a viewing angle of over 120-degrees.

One substantial drawback of LCD and PDP equipments is their low luminance, normally L=200˜400 cd/m². This luminance is insufficient for a high luminous display screen to display images. Another drawback of LCD and PDP is their low efficiency and high energy consumption. An LCD equipment consumes W=10 watt electric power for creating an image on a 100 cm² screen. The luminous efficacy of a PDP equipment is low, η=1˜3 lumen/watt. When a PDP equipment consumes 1 watt electric power to create an image on an area of 1 m², the luminance is simply less than L=1 cd/m².

LCD has a high cost. PDP has a low resolution. In consequence, new message display architecture in flat panel display industry must be created. The new architecture, field emission display (FED), then is created. FED architecture uses large-area field electron sources to provide electrodes for striking colored cold cathode electroluminescent phosphor to produce a color image. It consists of a matrix of cathode ray tubes each tube producing a single sub-pixel, grouped in threes to form red-green-blue (RGB) pixels. Cold cathodes do not cause temperature during working. The fabrication of this architecture requires excellent human (handicraft) technique to make thin and sharp metal materials, i.e., molybdenum (Mo) and tungsten (W). The technique for the production of this architecture is complicated and, the cost is high. At the present time, a hollow carbon nano-tube (CNT) is used as an emitting cathode for creating a novel CNT-FED architecture. In this architecture, silver-screen printing technique is employed to make a cathode matrix of carbon nano-tubes.

FIG. 2 is a cross-sectional view of a conventional CNT-FED. As illustrated, the CNT-FED comprises a cathode 10, an anode 20 and conducting electrodes 30, located between the cathode 10 and the anode 20. Carbon nano-tubes (CNTs) are established between the surface of the internal thin plate of the anode 20 and the conducting electrodes 30. A carbon nano-tube has a very thin wall, not greater than 10 μm. At this gap of 10 μm, a second layer of the same structure is located on a second anode plate to cover a RGB light-emitting element, normally made of a transparent conductive material, yttrium oxide or tin oxide. A special technique is employed to support the cathode plate and the anode plate with a gap about 10˜100 μm left there between. During the operation, the space between the cathode plate and the anode plate is maintained in vacuum. Carbon nano-tube electrodes are arranged on the cathode plate. The Electric potential energy of the internal thin plate, U=500V, is sufficient to create an electric field gradient, G=U/S=500V/10×10⁻³ mm=50 KV/cm, in the vacuum space for drawing all electrons out of the CNT layer. This electric field gradient passes through the cathode plate and the anode plate. Electrons from the carbon nano-tubes fly through the vacuum space to strike phosphor dots at the anode plate, creating electroluminescence. When compared to a regular cathode-ray tube, the electric energy applied in a FED equipment is about 50˜100 times lower than that in a cathode-ray tube. In a CNT composition, the electron beam space density is not greater than 10 μA/cm², much smaller when compared to CRT.

To cause the phosphor at the anode plate to emit light (or to be lighted up), a starting potential energy is necessary. The starting potential energy is marked as E₀. It starts to work when energy reaches E₁. When operation, luminance, L, and the energy parameters were recorded according the equation, L=ζ(E₁−E₀)ⱼⁿ. L is for the luminance, E1 is for the energy beam falling at the surface of the phosphor; n is for a nonlinear index, n≧1.5˜2; J is for the current density. When E₁>E₀, electroluminescence is created. Normally, the starting potential energy is E₀=1˜2×10²V However, in CNT-FED, E₁=500V can cause electroluminescence.

Thus, an important conclusion is obtained that the parameter of E₀ must be lowered to 10˜50V, which is very difficult to achieve.

A second requirement is high conductivity in the luminescence mosaic layer. In a CNT-FED monitor, high conductivity of gate electrode is assured when current is full loaded. This gate electrode must be kept in good contact with the electric dot of cathode luminescence particles. This condition can be achieved only when the layer of the phosphor particles is thin.

A third requirement is that fine particle size of cathode electroluminescence phosphor is necessary for the production of a thin CNT-FED screen. For example, in WO/2008/002288 (refer also to Collins Thomas et al and WO/2008/002288 Luminescent materials for a carbon CNT-FED. Jan. 3, 2008), CNT-FED is not suitable for activation with a huge energy. Moreover, let's use the equipment, used in the patent application case WO/2008/003388A1, to disassemble a FED monitor based on cathode electroluminescence carbon nano-tube. The anode is now connected in series to RGB emitters, and the starting electron beam energy is E₀=4˜10 kV. The screen utilizes the well-known conventional light emitting material for TV, which are green radiation cathode electroluminescence phosphor, contains the component of ZnS.CuAl; blue radiation cathode electroluminescence phosphor, contains the component of ZnS.AgCe; and red radiation cathode electroluminescence phosphor, contains the rare earth component of Y₂O₂S.Eu.

This well-known phosphor display screen has drawbacks: 1. Using high voltage for activation; 2. To a standard TV grade cathode phosphor requiring starting electron beam energy E₀=4˜10 kV, high potential energy is required to light up TV grade cathode phosphor; 3. Particle size of cathode electroluminescence particles used in the TV phosphor screen; and 4. Not in favor of highly particle dispersed high performance cathode luminescence display screen.

### SUMMARY OF THE INVENTION

The present invention has been accomplished under the circumstances in view. The purpose of the present invention is to provide a trichromatic field-emission display and phosphors thereof to eliminate the aforesaid drawbacks.

Firstly, the present invention provides a trichromatic field-emission display and phosphors thereof to create an internal vacuum gap in the CNT-FED display without equipping any electronic devices.

Secondly, the present invention provides a trichromatic field-emission display and phosphors thereof to improves the luminance of CNT-FED display and enhances anode plate binding strength.

To achieve the goals of the present invention mentioned above, a trichromatic field-emission display comprises a cathode plate, three cathode electroluminescent phosphor screens and an anode plate. The anode plate has a transparent oxide thin film bonded to the photo gate electrode thereof. Electron sources emitted by the photo gate electrode of the cathode plate strike the cathode electroluminescent phosphor screens to cause change of the electric field in the gap between the cathode plate and the anode plate. The cathode electroluminescent phosphor screens are made of an excitable rare earth element, which assuring high stability and uniformity of the screen's luminance when they are excited by an electron beam.

### BRIEF DESCRIPTION OF THE DRAWINGS

FIG. 1 is a schematic drawing showing a cold cathode type field-emission phosphor screen based CRT display architecture according to the prior art.

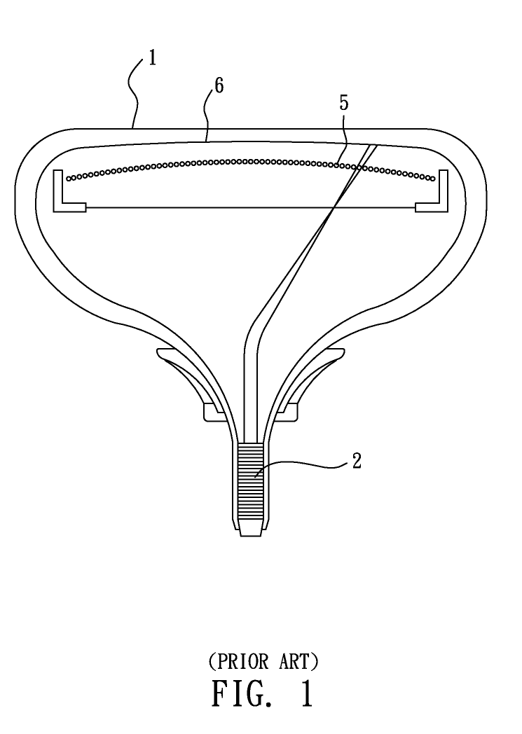

FIG. 2 is a schematic cross-sectional view of a carbon nano-tube field-emission display according to the prior art.

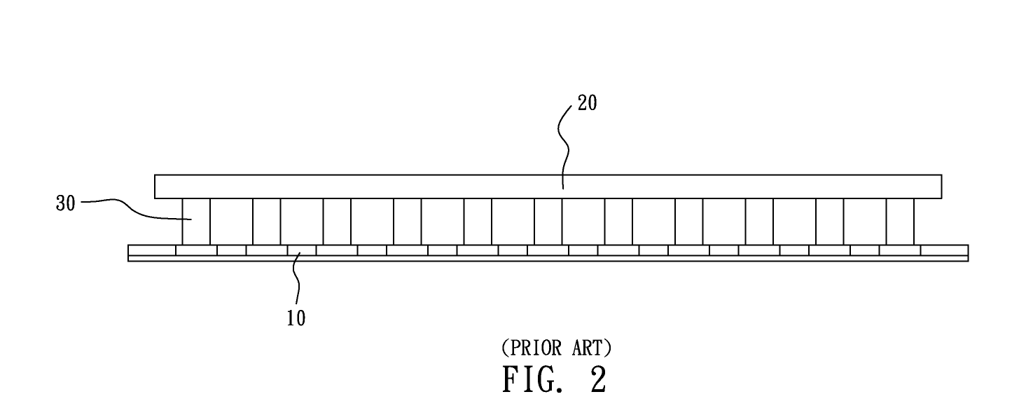

FIG. 3 is a schematic cross-sectional view of a carbon nano-tube field-emission display according to the present invention.

FIG. 4 is a schematic drawing showing the luminous efficiency of the carbon nano-tube field-emission display according to the present invention.

### DETAILED DESCRIPTION OF THE PREFERRED EMBODIMENT

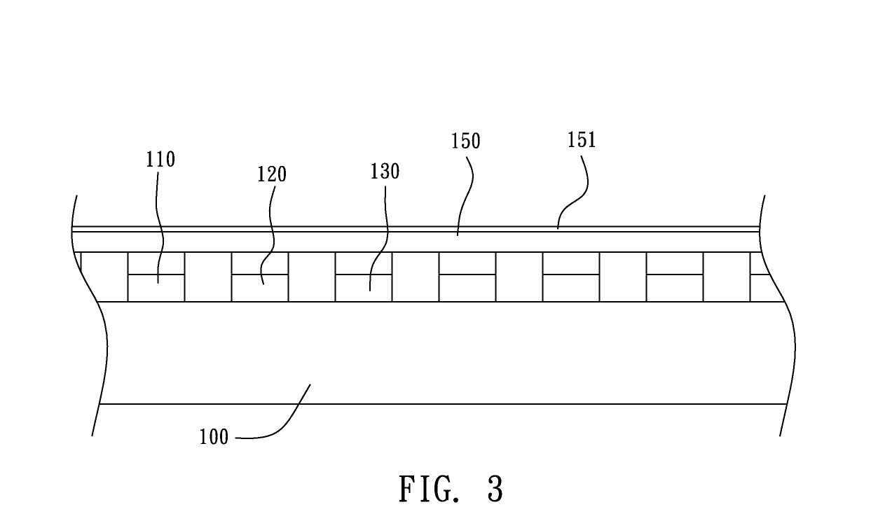

At first, the main object of the present invention is to eliminate the drawbacks of the aforesaid prior art phosphor screen. FIG. 3 illustrates a cross-sectional view of carbon nano-tube field-emission display according to the present invention. As illustrated, this trichromatic field-emission display comprises a cathode plate 100, three cathode electroluminescent phosphor screens 110, 120, 130, and an anode plate 150.

The anode plate 150 has a transparent oxide thin film 151 bonded to the photo gate electrode thereof. Electron sources emitted by the photo gate electrode of the cathode plate 100 strike the cathode electroluminescent phosphor screens 110, 120, 130, causing the electric field in the gap between the cathode plate 100 and the anode plate 150 to be changed, characterized in that the cathode electroluminescent phosphor screens 110, 120, 130, made of an excitable rare earth element, are assured with high stability and uniformity luminance when they are excited by an electron beam.

Further, the rare earth element is an yttrium compound. The energy of the electron beam is E>400V. When the median particle diameter of the cathode phosphor is d₅₀<1 μm, the density will be p≦5 g/cm³.

Further, each unit of each of the cathode electroluminescent phosphor screens 110, 120, 130 is covered with a cathode electroluminescence phosphor in a dispersed circular or oval shape (not shown), wherein the size of each unit is: d=0.1˜0.25 mm.

The red radiating light component uses the cathode electroluminescent phosphor: Y_{2-x-y-z}ScₓIn_{y}Eu_{z}O₃ where x=0.001˜0.1, y=0.001˜0.1, z=0.001˜0.1.

The green radiating light component adopts yttrium orthosilicate, uses cerium and terbium as activators and has scandium and tin added thereto, and the related phosphor is prepared subject to the formula: Y_{2-x-y-z}ScₓTb_{y}Ce_{z}Si₁₋ₚSnₚO₅, wherein x=0.001˜0.1, y=0.001˜0.1, z=0.001˜0.1, p=0.001˜0.1.

The blue radiating light component adopts organic yttrium silicate-based cathode luminescence phosphor that uses cerium as activator and has scandium ions and tin ions added thereto, and the chemical equivalent equation of the phosphor is Y_{2-y-z}ScₓGd_{y}Ce_{z}Si₁₋ₚSnₚO₅, wherein x=0.001˜0.1, y=0.001˜0.1, z=0.001˜0.1, p=0.001˜0.1.

There are Cr₂O₃ compact absorption layers spaced among monochrome lines.

The cathode plate 100 further has a silver coating surface layer (not shown) that is packaged in the form of a carbon nano-tube electro-emitting layer.

The transparent oxide thin film layer 151 is SnO₂ and/or InO₃.

The physical features of the trichomate field-emission display in accordance with the present invention are outlined hereinafter. In FIG. 3, the two electrode plates 100, 150 are separated by the CNT cathode coating layer and the anode coating layer of the cathode electroluminescent phosphor screens 110, 120, 130, defining a vacuum space of width 100 μm.

In the dimension of the thin plate provided according to the present invention, the potential voltage varies within the range of 100V˜800V In the electric field at the vacuum gradient of ζ=100V/10⁻³ mm=1×10⁵ V/mm, the potential energy is U=100V. This value is insufficient to the CNT free electron energy in the vacuum, therefore electroluminescence at the anode plate does not occur.

When electric field increases to U=400V, interrupted spot luminance at the anode plate 150 follows. Luminance is not uniform at this time. This phenomenon explains that different colors of cathode light-emitting particles have different starting potential energy E₀.

When voltage is increased to U=500V, RGB trichromatic anode plate 150 starts to emit light. As discovered in early works, when the electric potential energy U=600V, the suggested phosphor screen architecture runs (works) fully. When U=650˜750V, uneven luminance is completely disappeared. Differences are seen. The most significant difference is that when potential energy U=10000V, the value is high, the voltage is low, the suggested implement has a vacuum gap therein, and the test shows instability.

A second difference is seen that in the phosphor screen architecture as shown in FIG. 3, the three different colors of cathode electroluminescent phosphor screens 110, 120, 130 show uniform red, green and blue colors when U=400V.

A third difference is seen that the luminance of these three different colors light emitting components is about dozens of candelas per square meter to hundreds of candelas per square meter. In equation, the luminance L of the cathode electroluminescent phosphor screens 110, 120, 130 is ζ(E₁−E₀)jⁿ, wherein “n” is greater than 1, 1<n≦3. “n” is obtained subject to reasonable physical concept. According to the penetration depth of electrons in a cathode light-emitting substance, the equation is obtained as: ρδ=10⁻⁵U^{3/2} wherein, ρ is the density of the cathode light-emitting substance, g/cm³; δ is the penetration depth of electrons in the cathode light-emitting substance that has a great concern with the concentration of the activated atoms in the cathode light-emitting substance; U is the voltage. Obviously, increasing penetration electric energy causes change of cathode luminance because an increase of nonlinear coefficient luminance in cathode light-emitting is about n=1.5.

From this point of view, it is quite obvious why the invention uses yttrium compound-based cathode phosphors. The use of yttrium compound-based cathode phosphors has the advantages as follows: (1) independent yttrium atoms have a relatively lower density about 4.1˜4.95 g/cm³; (2) independent yttrium has a high concentration of activated atoms in the light-emitting material; (3) linking yttrium, independent oxygen and reliable chemical, evaporated at the temperate of T˜4000K, leaving little dot defects due to the reason of low starting potential energy E₀.

It is to be emphasized that yttrium compound-based cathode electroluminescence phosphor is well known, and this invention utilizes the advantages of yttrium for successfully producing a high-performance CNT-FED cathode luminescence phosphor screen.

Table I is a comparison table showing significant parameters differences between the suggested oxygen-contained yttrium compound-based cathode phosphor and the known prototype phosphor.

TABLE I

| | Known three | | | Suggested oxygen-contained | | |
|---|---|---|---|---|---|---|
| | valence electrons | | | yttrium compound-based cathode | | |
| Cathode phosphor | cathode phosphor | | | phosphor | | |
| parameters | ZnCdS:CuAl | ZnS:Ag | Y₂O₂S:Eu | Y₂SiO₅:Tb | Y₂SiO_{5.6}:Ce | Y₂O₃:Eu |
| Material density | 5.0 | 4.2 | 4.95 | 4.4 | 4.4 | 5.0 |
| g/cm³ | | | | | | |
| Concentration of | 0.1 | 0.5 | 5 | 6~8 | 2~4 | 8 |
| activator atoms % | | | | | | |
| Luminance at | 0.3 | 0.36 | 0.28 | 0.35 | 0.32 | 0.32 |
| U = 1 kV | | | | | | |
| Brightness when | 100 | 100 | 100 | 260 | 280 | 200 |
| below U = 1 kV | | | | | | |
| Luminance at | 100 | 100 | 100 | 60 | 80 | 85 |
| U = 10 kV | | | | | | |

The data show that the luminance of the CNT-FED cathode luminescent phosphor screens is increased by about 2.5˜3 times compare to the well-known standard luminance, which enhances electron beam penetration depth in the yttrium compound cathode luminous substance.

The data shown in Table I explain the advantages of choosing suitable luminous material by the present invention. When U=10 kV, we can only adopt the standard cathode luminescence phosphor which is made of sulphide, contains three valence electrons, When U<1000V, the composition of green radiation cathode luminescence phosphor Y₂SiO₅:T_{B} has a luminance about 2.6 times higher than that of the standard ZnSAgCl. In Table I, reasonable use of Y₂SiO₅:T_{B} in the CNT-FED phosphor screen subject to the present invention takes the first place in effective brightness.

To compare Y₂O₂S:Eu and Y₂O₃S:Eu which are with similar density, the Y₂O₃S shows the luminous efficiency 2 times higher than that of the former one when energy of electron beam U=1000V It may be that the activated concentration of luminous atom Eu in the substrate of Y₂O₃S:Eu(8%) is relatively higher when compared to that in Y₂O₂S:Eu(5%).

The advantage of yttrium cathode electroluminescence in CNT-FED display is quite important. It is characterized that cathode electroluminescence phosphor in the coating layer of the display has a density 4 g/cm³≦δ≦5 g/cm³, and an average particle size: d₅₀≦1 μm. The luminance of the cathode electroluminescence substance is supposed to rise when the substance is deeply penetrated by the electron beam. However, when the particle size d<1 μm, the electron beam penetrates the cathode electroluminescence substance completely, the performance will be lowered, and in consequence the total luminance of the phosphor screens will be relatively reduced.

It is assured in this invention that the average diameter of optical particles of the cathode electroluminescence phosphor is d≦1 μm. This selected diameter is determined that micro particle size at V=4/3πr³=4 μm² shows an average dielectric E=6˜8 units, not allowable for cumulation of a big amount of static electricity. When static electricity is gathered in phosphor particles, a repulsive effect will be produced against the glass substrate, causing the phosphor coating to peel off from the glass substrate and lowering current density. This is the substantial drawback of FED phosphor architecture. When using electrons to excite cathode electricity to the luminous phosphor, it lowers the adhesion of the phosphor particles. This problem can be overcome by means of improving the adhesion of micro cathode luminous particles. A second important benefit is substantial rise of covering power. When the phosphor amount on the substrate reaches 2 mg/cm² and d₅₀=2 μm, the coating area of the phosphor is simply about 67% of the total area; when d₅₀=1 μm cathode electroluminescence phosphor is taken away, the coating area becomes greater, up to 95%, and consequently the load of the phosphor on the phosphor screens is reduced to the level of M=1 mg/cm².

The suggested composition exhibits important benefit in micro cathode electroluminescence phosphor. The micro cathode electroluminescence phosphor in the phosphor screen pixels allow establishment of uniform and precision size of pictograph, which is sufficient for obtaining an excellent and colorful picture. By means of enhancing the adhesion of the phosphor particles, the clarity of the CNT-FED display is improved.

The invention has another important benefit. The comparison between the cathode electroluminescence particles, which raise radiation area, and flat glass display panel is a comparison between layer and particles. Assume that the cross-sectional area of every cathode electroluminescence particle is about 1 μm², when the cross-sectional area of each and every particle reaches S≦0.5 μm, the ratio between particle surface area and flat panel glass area is nearly doubled, and more importantly, electron beam current can be reduced to a half of the original volume. The invention has emphasized the nonlinear physical operation of cathode electroluminescence early. The radiation boundary of the equation is n>1.0, reversed to excitation energy, and the relationship with current excited density j=J/S.

When the amount of the micro cathode electroluminescence phosphors in the phosphor screen is doubled, and the actual total current is reduced to a half, the related effective nonlinearity is relatively reduced.

This sample selected suitable optical cathode luminous particle size, and provides important advantages as follows: 1. Improves the adhesion of particles to the phosphor screen substrate; 2. Improves luminance and lowers nonlinearity; 3. Improves the limitation of clarity caused by complicated and interrupted coating of cathode electroluminescence. The CNT-FED architecture provided subject to the present invention is characterized in that the cathode electroluminescence phosphors are coated in the form of continuous pixels, having a geometric size e₁=0.11 mm to e₂=0.25 mm.

FIG. 3 shows the interrupted pixel coating of the cathode electroluminescence phosphor screens. The cathode electroluminescent phosphor screens 110, 120, 130 have a width not greater than 20˜100 μm. The gap width of every single pixel is Δ=50 μm.

In the following CNT-FED display architecture, a black substance is used as a spacer, improving image contrast in the display. Subject to the architecture of the present invention, the width of the spacer is suggested to be within about ⅓ to ½ of the total width of the phosphor screen, eliminating breakdown among the interrupted cathode electroluminescence layers.

The substantial phosphor material architecture of the cathode electroluminescence phosphor screen is outlined hereinafter. The oxygen-contained, yttrium-based RGB cathode electroluminescence materials are numerous, such as yttrium oxide europium/sulphur/yttrium/gadolinium, orthohydrogen garnet, organic silicon (compound) garnet, and etc.

The invention is prepared subject to the factors of: 1. Density 4.0≦ρ≦5 g/cm³; 2. Excitation concentration of cerium is 6˜8%; 3. Possibility of obtaining micro dispersed particles; 4 Possibility of high conductivity and synthesis of cathode electroluminescence; and 5. Low constant dielectric value.

Oxygen-yttrium cathode electroluminescence parameters suggested according to the present invention are activated by europium and have Sc⁺³ ions added thereto. The material suggested according to the present invention has the stoichiometric equation of: Y_{2-x-y-z}ScₓIn_{y}Eu_{z}O₃ where x=0.001˜0.1, y=0.001˜0.1, z=0.001˜0.1. It is to be understood that the introduction of the extra cathode luminescent Sc⁺³ ions causes a rise in cathode luminance by 7˜10% and a rise in red mass. The concentration of added scandium ions is preferably within 1˜10%, or most preferably within 5˜6%.

We believe that add ZnO to the cathode luminescent particle ions enable the low resistance characteristic of ZnO to be exhibited so that the resistance can reach the level of R=10⁶ Ohm/cm. We found that introduction of oxide increases the adhesion of the red phosphor particles on the anode plate. This explains that a rise of the conductivity of cathode electroluminescence particles improves particle current load, reduces cumulation of static electricity and improves the adhesion of material particles.

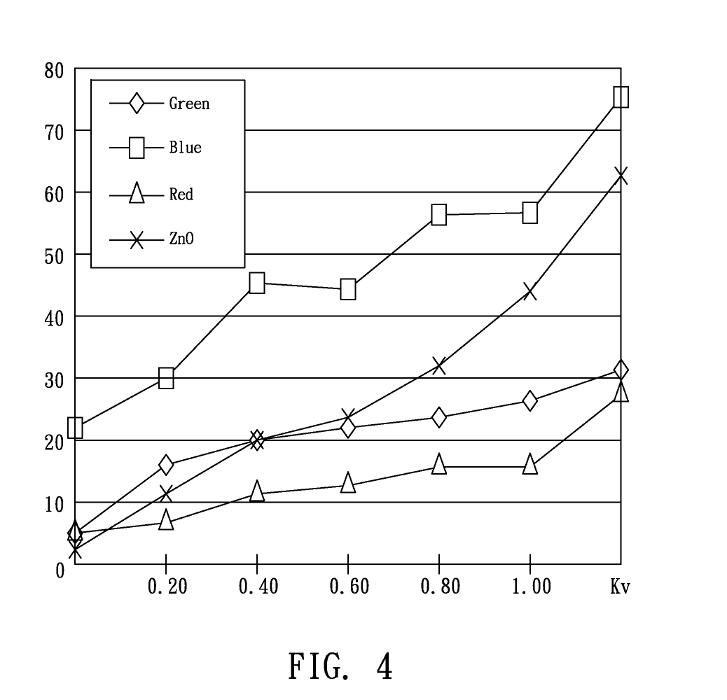

FIG. 4 illustrates the luminous efficacy of the carbon nano-tube field-emission display according to the present invention. As illustrated, the luminous efficacy (lumen/watt) of the RGB luminance of the cathode electroluminescence phosphor screens 110, 120, 130, shown in FIG. 3, remains unchanged and is about 10 lumen/watt higher than that of red phosphor particles.

The red radiation luminescence parameter has the form of Y_{2-x-y-z}ScₓIn_{y}Eu_{z}O₃ where x=0.001˜0.1, y=0.001˜0.1, z=0.001˜0.1.

With respect to the radiation of the cathode phosphors suggested according to the present invention, 90% of the energy is used for electron transition ⁵D₂-⁷F of Eu⁺³ for radiation luminescence. The material composition prepared according to the present invention not only causes a rise in luminance but also improves luminescence chromaticity. When [Eu]=2%, the color coordinates are x=0.62, y=0.36; when increasing [Eu] to 4%, 6% or 8%, the color coordinates will become: x=0.635, y=0.348 to x=0.648, y=0.358.

At last, the coordinate value is saturated red for creating different clear red pixels. The most important is to accurately improve the cathode electroluminescence luminance of Y₂O₃.Eu. According to test and analysis, when Sc₂O₃ is introduced into the composition, improvement of the cathode electroluminescence luminance can be seen at U=5 KV as well as at U=400˜600V. The last determination is at the internal transition absorption activity of K to L in Sc³ ions (1s²2s²2p⁶3s²3p⁶4s²3d¹).

We believe that this supplementary absorption is the major factor that causes a rise in the red radiation of the aforesaid cathode electroluminescence phosphors.

The CNT-FED display also uses a yttrium-based green cathode electroluminescence phosphor. Using the similar material to the red radiation phosphor is because of the advantages of: 1. The density value is low when enhanced penetration depth of electron beam in phosphor particles; 2. It enables the phosphor to release more activation energy and 3. It allows creation of phosphor materials have a less number of dot detects.

According to the present invention, orthosilicate-yttrium substrate-based cathode electroluminescence phosphor uses terbium and cerium as activators, characterized in that the composition has scandium (Sc) and selenium (Sn) ions introduced therein; the stoichiometric equation is: Y_{2-x-y-z}ScₓTb_{y}Ce_{z}Si₁₋ₚSnₚO₅ where X=0.001˜0.1, y=0.001˜0.1, z=0.001˜0.1, p=0.001˜0.1.

When under the circumstance of relaitvely lower electron beam energy U=300˜800V, this orthosilicate-yttrium substrate-based cathode electroluminescence phosphor has a relatively higher luminance; under a long period electron beam radiation, it shows high stability.

To the B2/B space structure coupled monoclinic composition architectures Sc₂SiO₅ and Y₂SiO₅, density ρ in scandium/yttrium orthosilicate is different. If the density of Sc₂SiO₅ is ρ=3.49 g/cm³, density of Y₂SiO₅ is ρ=4.49 g/cm³, 10% Sc₂O₃ should be introduced therein. When the density of the cathode electroluminescence phosphor is allowable to be reduced, enhancing penetration of electron beam through the material increases the luminance. Slid solution Sc₂SiO₅—Y₂SiO₅ that uses 10% Tb₂SiO₅ cathode luminance solution as the substrate can modify the shape of the single crystal.

According to the present invention, orthosilicate yttrium is introduced into the luminous conductive component. The cathode electroluminescence phosphor is obtained by means of solid-state synthesis. Y₂O₃, Sc₂O₃, Tb₄O₇ and CeO₂ are prepared and dissolved in 3M nitric acid, and then heated. The solution thus obtained is then mixed with NH₄OH, thereby obtaining solution Y(OH)₃, Sc(OH)₃, Tb(OH)₃, Ce(OH)₃. The chemical equivalence ratio is: 0.80:0.12:0.03:0.001.

The liquid mixture thus obtained is then mixed with SiO₂, in which the molecular proportion is [ΣLn(OH)₃]:[SiO₂]=1:1. Thereafter, the mixture is heated to T=1300° C.˜T=1500° C. for 2 hours. The product thus obtained is washed with hot water, and then air-dried, and then examined with a professional equipment.

Test proved the suggested cathode electroluminescence phosphor has luminous efficacy ζ=36˜40 lumen/watt when the electron beam energy E=5 kV. This high luminous efficacy is not seen in prior art designs.

In the test experiment, CNT-FED phosphor screen uses paste-like phosphor, which assuring high energy luminance performed by electron beam with U=300V.

Blue radiation cathode luminescence of CNT-FED display is complicated. The known cathode luminescence phosphor ZnS:AgAl has low brightness and high electron activation threshold value. An orthosilicate yttrium substrate-based cathode luminescence phosphor, according to the present invention, uses cerium as an activator and has introduced therein magnesium oxide and tin oxide. The phosphor has the stoichiometric equation: Y_{2-x-y-z}ScₓGd_{y} Ce_{z}Si₁₋ₚSnₚO₅ where x=0.001˜0.1, y=0.001˜0.1, z=0.001˜0.1, p=0.001˜0.1.

The blue cathode luminescence phosphor according to the present preferred embodiment has magnesium oxide introduced therein. During preparation, we adopt oxides Y₂O₃, CeO₂ for reaction with SiO₂ at a high temperature T=1300˜1500° C. for 2˜8 hours. The product thus obtained is washed with hot water, and then air-dried in a wind box. Thereafter, it is tested in a CNT-FED display.

We discovered that when U-250V, threshold luminescence was seen at the cathode electroluminescence phosphor screens 110, 120, 130. Phosphor screen package does not carry static electricity. Tin oxide substrate-based cathode electroluminescence phosphor determines the conductivity in which the cathode excistes phosphor particles.

Every suggested cathode phosphor is made on the photo gate bottom panel in the display screen by means of silk-screen printing. When preparing the paste-like coating, polymer is combined with phosphor particles, and then the mixture is applied to the photo gate bottom panel by means of silk-screen printing.

Broad stripes of phosphor layer have the size of 100˜200 μm. Spacer between luminescence stripes has the size of 60˜80 μm.

During the study, we discovered that material filled contact layer is provided in between luminescence stripes that absorb external radiation strongly. The invention suggests the combination of oxygen and Cr₂O₃. Red particles have reliable thermal stability. Cr₂O₃ layer has fine particles (d≦0.2 μm). Cathode luminescence particle component is marked on the surface of the glass substrate. Green, red and blue display layers are alternatively coated in the display. In the RGB stripe (360 μm) architecture, color absorption portion has the size of 180˜240 μm, sufficient to obtain the contrast ratio of 100:1.

In the architecture of the cathode plate prepared according to the present invention, carbon nano-tube is used as field emission base element. The hollow inside wall has a thickness of one nanometer. Each piece has a length of about 0.5 mm. Fibers are interlaced. Carbon nano-tube (CNT) fibers are arranged on special thin-film silver lines. This Ag thin film is coated on the cathode plate by means of vacuum evaporation technology. Glass surface is sintered at 400° C.

Carbon nano-tube (CNT) can be made in two ways. A first way is to decompose FeC₃₂N₈H₁₆ at a high temperature. When electric field gradient is below 2.35V/μm, CNT packaged emitter has a current density 10 mA/cm². A second way is to decompose CH≡CH at a high temperature, thereby obtaining carbon nano-tubes. Under this condition, CNT current density is J=8.7 mA/cm², however the electric field gradient is lowered to about a half.

During preparation, a thin film Ag layer is coated on the cathode plate. A small amount of Cu(NO₃)₂ and Ni(NO₃)₂ is added to carbon nano-tube suspension in alcohol solution, thereby forming electro-coating.

Carbon nano-tube suspension is electrolyzed in isopropyl alcohol. Steel base plate is used as one electrode. The applied voltage is U=25V Thus, CNT layer, with the thickness of 6=5 μm, is formed on the surface of the silver coated electrode. Under the calcination temperature T=400° C., CNT layer is dispersed, thereby obtaining a compact emitter coating (package).

Thereafter, prepare the desired cathode plate and anode plate separately (individually). The cathode plate and the anode plate are then arranged in the interrupted cathode luminescence layers and the emitter layer.

The thin plates are arranged on ceramic spacers at an equal distance. Each spacer has a thickness of 170 nm (±1 nm). Spacers are installed by a machine or by labor. A gap of 10 mm is left between each adjacent spacer. The machine works at a constant speed. The end face of the glass thin plate is coated with SrO, PbBO.SiO₂ and Fe₂O₃. The thin plate has a thickness e≈300 μm, sufficient for tight bonding between the cathode plate and the anode plate.

A special glass is melted in the thin plate. Sintering process at a maximum temperature of 460° C. is performed through 4˜6 hours. An extraction glass tube is affixed to one end of the implement. When temperature reaches T=320˜360° C., draw air away from the implement to avoid planar gas source conduction breakdown. Remove the extraction glass tube after sintering for 180 minutes. The implement is maintained at a vacuum state of vacuum pressure ρ=10⁻⁸ mmHg for a long period.

Although a particular embodiment of the invention has been described in detail for purposes of illustration, various modifications and enhancements may be made without departing from the spirit and scope of the invention. Accordingly, the invention is not to be limited except as by the appended claims.

What is claimed is:

1. A trichromatic field-emission display, comprising a cathode plate, three cathode electroluminescent phosphor screens and an anode plate, said anode plate having a transparent oxide thin film bonded to its photo gate electrode, electron sources emitted by said photo gate electrode of said cathode plate striking said cathode electroluminescent phosphor screens to cause change of the electric field in the gap between said cathode plate and said anode plate, wherein said cathode electroluminescent phosphor screens are made of an activated rare earth element, assuring high stability and uniformity of luminance when excited by an electron beam.

2. The trichromatic field-emission display as claimed in claim 1, wherein said rare earth element is an yttrium compound.

3. The trichromatic field-emission display as claimed in claim 1, wherein the energy of said electron beam is E>400V.

4. The trichromatic field-emission display as claimed in claim 1, wherein each unit of each of said cathode electroluminescent phosphor screens is covered with a cathode electroluminescence phosphor in a dispersed circular or oval shape, and the diameter of each unit is: d=0.1˜0.25 mm.

5. The trichromatic field-emission display as claimed in claim 4, wherein when the median particle diameter of the cathode phosphor is d₅₀<1 μm, the density value is ρ≦5 g/cm³.

6. The trichromatic field-emission display as claimed in claim 4, wherein the red radiating light component uses the cathode electroluminescent phosphor, Y_{2-x-y-z}ScₓIn_{y}Eu_{z}O₃ where x=0.001˜0.1, y=0.001˜0.1, z=0.001˜0.1.

7. The trichromatic field-emission display as claimed in claim 4, wherein the green radiating light component uses yttrium orthosilicate and uses cerium and terbium as activators and has introduced therein scandium and tin, and the related phosphor is prepared subject to the formula, Y_{2-x-y-z}ScₓTb_{y}Ce_{z}Si₁₋ₚSnₚO₅, wherein x=0.001˜0.1, y=0.001˜0.1, z=0.001˜0.1, p=0.001˜0.1.

8. The trichromatic field-emission display as claimed in claim 4, wherein the blue radiating light component uses organic yttrium silicate-based cathode luminescence phosphor that uses cerium as activator and has scandium ions and tin ions added thereto, and the chemical equivalent equation of the phosphor is: Y_{2-x-y-z}ScₓGd_{y}Ce_{z}Si₁₋ₚSnₚO₅, wherein x=0.001˜0.1, y=0.001˜0.1, z=0.001˜0.1, p=0.001˜0.1.

9. The trichromatic field-emission display as claimed in claim 1, wherein Cr₂O₃ compact absorption layers are spaced among monochrome lines.

10. The trichromatic field-emission display as claimed in claim 1, wherein said cathode plate further has a silver coating surface layer that is packaged in the form of a carbon nano-tube electro-emitting layer.

11. The trichromatic field-emission display as claimed in claim 1, wherein said transparent oxide thin film layer is SnO₂ and/or InO₃.
